(19) United States
(12) Patent Application Publication
(10) Pub. No.: US 2024/0154157 A1
(43) Pub. Date: May 9, 2024

(54) THE PRODUCTION OF MELT FORMED INORGANIC IONICALLY CONDUCTIVE ELECTROLYTES

(71) Applicant: Thermal Ceramics UK Limited, Merseyside (GB)

(72) Inventors: Martyn Brown, Merseyside (GB); Richard Clark, Hayward, CA (US); William Thomas, Merseyside (GB)

(73) Assignee: Thermal Ceramics UK Limited, Merseyside (GB)

(21) Appl. No.: 18/281,669

(22) PCT Filed: Mar. 16, 2022
(86) PCT No.: PCT/GB2022/050667

§ 371 Date: Sep. 12, 2023

(30) Foreign Application Priority Data
Mar. 17, 2021 (GB) 2103712.2

(51) Int. Cl. H01M 10/0562; C01G 25/00; C04B 35/488; C04B 35/64; H01M 4/485; H01M 4/02

(52) U.S. Cl. CPC H01M 10/0562; C01G 25/006; C04B 35/4885; C04B 35/64; H01M 4/485; C01P 2002/02; C01P 2002/32; C01P 2002/34; C01P 2002/54; C01P 2002/72; C01P 2004/03; C01P 2004/32; C01P 2004/61; C01P 2006/40; C04B 2235/3248; C04B 2235/528; C04B 2235/5436; C04B 2235/5445; H01M 2004/021; H01M 2004/027; H01M 2300/0071

(57) ABSTRACT

Disclosed is a process for the production of lithium ion conductive shaped particles, or precursors thereof, comprising: feeding a mixture of raw materials into a melting vessel, melting the raw materials in the melting vessel to form a molten mass, shaping the molten mass, and quenching the molten mass to produce the particles,

wherein the cooling rate of the molten mass is sufficient to form a plurality of glass or glass ceramic particles and wherein the molten mass is shaped prior to or at the same time as being quenched by a fluid cooling medium.

### FIELD OF THE INVENTION

The present invention relates to the production of melt formed inorganic ionically conductive conductors for use within energy storage device, particularly as electrolytes or electrode materials.

### BACKGROUND

The development of solid lithium conductors has attracted considerable attention in recent years as the evolution of battery technology progresses towards higher energy density solutions. Garnet or garnet-like solid lithium-ion conductors have emerged as particularly promising candidates due to their excellent conductivity and wide electrochemical stability window.

U.S. Pat. No. 8,658,317 discloses garnet-like cubic crystal structures with the stoichiometric composition L₇₊ₓAₓG₃₋ₓZr₂O₁₂, where
L is in each case independently a monovalent cation,
A is in each case independently a divalent cation,
G is in each case independently a trivalent cation,
O≤x≤3 and
O can be partly or completely replaced by divalent or trivalent anions such as N³⁻.

L is particularly preferably an alkali metal ion, for example Li⁺, Na⁺ or K⁺. In particular, combinations of various alkali metal ions are also possible for L. In a particularly preferred embodiment of the invention, L=Na⁺. Sodium is very inexpensive and available in any amounts. The small Na⁺ ion can move readily in the garnet-like structures and in combination with zirconium gives chemically stable crystal structures.

A is any divalent cation or any combination of such cations. Divalent metal cations can preferably be used for A. Particular preference is given to alkaline earth metal ions such as Ca, Sr, Ba and/or Mg and also divalent transition metal cations such as Zn. It has been found that these ions move very little if at all in the garnet-like compounds according to the invention, so that ion conduction occurs essentially via L.

In the above composition, preference is also given to 0≤x≤2 and particularly preferably 0≤x≤1. In an embodiment according to the invention, x=0, so that A is not present in the garnet-like compound.

G is any trivalent cation or any combination of such cations. Trivalent metal cations can preferably be used for G. Particular preference is given to G=La.

An example of a particularly preferred compound according to the invention having a garnet structure is Li₇La₃Zr₂O₁₂ (LLZO). The high lithium ion conductivity, good thermal and chemical stability in respect of reactions with possible electrodes, environmental compatibility, availability of the starting materials, low manufacturing costs and simple production and sealing make Li₇La₃Zr₂O₁₂ a promising solid electrolyte which is particularly suitable for rechargeable lithium ion batteries.

The ionic conductivity of these garnet-like materials is enhanced in the cubic crystalline form. The cubic crystalline structure is thermodynamically stable at relative high temperatures (e.g. >600° C.), whilst the tetragonal crystalline structure is stable at room temperature. Whilst the utility of these garnet-like materials in energy storage devices and the like is not questioned, the adoption of these materials has been at least partially slowed by the complex and expensive processing routes required to produce them.

Current production methods include; (i) A sol-gel process wherein a solution (either aqueous or organic, typically acidic) is made using soluble salts of the desired elements. The prepared sol is then processed to give the desired form (e.g. powder, fibre, sinter pellet) and crystallised at elevated temperatures—typically >1000° C.—to achieve the preferred cubic crystalline phase. (ii) A mixed oxide method where the desired quantities of oxide raw materials or precursors are milled together before a firing step to crystallise the powder into the desired cubic form. The milling and firing steps are often repeated to achieve a homogeneous crystalline phase in the powder. Both methods of production are costly, either in terms of raw materials or processing cost due to the multiple step, batch synthesis.

Other methods such as nebulized spray pyrolysis, electrospinning and thin film processing either suffer from difficulties in scalability or low ionic conductivity.

US2019/0062176 addresses some of the problems associated with the need for repeated high temperature heat treatment through using a molten salt reaction to form LLZO cubic crystalline powder.

US2019/0173130 discloses the production of Nb doped LLZO through direct quenching or solidification to form an intermediate amorphous composition, which goes through a comminution process prior to being shaped into sintered beads at 1150° C.

EP3439072 discloses a solid electrolyte including an amorphous phase on the surface of the lithium ionic inorganic conductive layer. The amorphous phase assists in reducing the interfacial resistance between the solid electrolyte and an electrode.

WO2020/223374 discloses the formation of doped and undoped LLZO powder using microwave plasma processing. While this technique claims to produce high quality, high purity stoichiometric LLZO, there are still challenges to cost effectively scale up this technology as well as to produce a particle size distribution with a D50 greater than 50 nm.

While progress is being made in developing solid electrolytes and their production methods, there is still scope to further improve solid electrolytes and/or electrode materials which are able to be produced on a large scale.

### SUMMARY OF THE INVENTION

In a first aspect of the present invention, there is provided a process for the production of a shaped lithium ion conductive article, or precursor thereof, comprising the steps of:
A. Feeding a mixture of raw materials into a melting vessel;
B. Melting the raw materials to form a molten mass;
C. Shaping the molten mass; and
D. Quenching the molten mass to produce the shaped article
   wherein the cooling rate of the molten mass is sufficient to form a shaped article, wherein the molten mass is shaped prior to or at the same time (i.e. simultaneous) as being quenched. The shaped article may be a sheet, a film, a particle, platelet or a fibre.

The melting vessel may be a furnace and in particular an electric furnace, such as an electric arc or induction furnace. The furnace may be readily scalable from a kilogram capacity of a 10 tonne capacity up to a capacity of 100 tonne or more.

The shaping of the molten mass may occur from a molten mass stream flowing from the melting vessel (e.g. being tapped from the furnace) through a tapping orifice or nozzle. The shaping of a stream of molten material further enhances the ability of the process to maximise output. In one embodiment, the molten mass stream, which is impinged by the fluid cooling medium, comprises a plurality of droplets.

In some embodiments, the process may include at least two melting vessels, with one melting vessel providing a molten stream for shaping, whilst the other melting vessel is in the process of melting the raw materials into a molten mass. Within this configuration, a near continuous stream of molten material may be supplied for shaping, thereby maximising output of the process.

The shaping of the molten mass (e.g. molten stream) may be achieved by impingement with a fluid stream. The volume and velocity of the fluid stream may be adjusted to control the particle size distribution of the resultant solidified particles. The particles may be generally spherical due to the effects of surface tension of the particles in their molten state. The particle size distribution (PSD) of the resultant particles is preferably such that no further or minimal comminution steps are required to obtain the target PSD. Minimal comminution steps may include no more than one or two comminution steps and/or a reduction in the D50 of no more than 15 μm or no more than 10 μm.

Alternatively, the shaping of the molten mass may occur through directing the molten mass through a nozzle to atomise the molten mass into particles. The atomisation may be conducted in an inert atmosphere. The atomised particles may be projected into a quenching medium, such as a quenching fluid and/or quenching surface. Additional details of such as process is disclosed in U.S. Pat. No. 4,781,741, which is disclosed herein by reference.

The raw materials, including optional dopants, are preferably selected to provide a composition which is capable of forming an ionically conductive crystalline phase or an ionically conductive semi-crystalline phase. The shaped article may initially comprise or consist of an amorphous phase, depending upon the end use application, the shaped articles may be further transformed into an ionically conductivity crystalline or semi-crystalline phase. Providing shaped articles which may be produced on a commercial scale (e.g. tonnes per day) with a defined shape and morphology will satisfy the demand within the growing energy storage device market. Advantageously, the process of the present invention enables such shaped articles to be produced with minimal or no grinding steps.

The composition of the shaped article preferably comprises a crystalline phase with an ionic conductivity (lithium ion) of at least of 1.0×10⁻⁶ S cm⁻¹ or at least 1.0×10⁻⁵ S cm⁻¹ at 30° C. or room temperature or an amorphous component which is capable of being transformed to an ionically conductive crystalline phase (e.g. through heat treatment).

In one embodiment, the composition corresponds to a composition capable of forming a garnet or garnet-like crystalline phase (preferably cubic) and/or an amorphous component which is capable of being transformed to a garnet-like crystalline phase (e.g. through heat treatment).

In another embodiment, the composition corresponds to a composition capable for forming perovskite (e.g. lithium lanthanum titanium oxide—Li₃ₓLa_{2/3x}TiO₃) or a perovskite-like crystalline phase and/or an amorphous component which is capable of being transformed to a perovskite or perovskite-like crystalline phase (e.g. through heat treatment). In addition to being used as electrolyte material, lithium lanthanum titanium oxide may be used as an electrode material.

In a further embodiment, the composition corresponds to a composition capable of forming a spinel or spinel-like crystalline phase, (e.g. lithium titanate, such as Li₄Ti₅O₁₂) or an amorphous component which is capable of being transformed to said crystalline phase (e.g. through heat treatment). In addition to being used as electrolyte material, the compositions may be used as an electrode material (e.g. anode material).

In some embodiments, the shaped article(s) is predominately (i.e. at least 50 wt %) amorphous. In some embodiments the shaped article(s) has a major amorphous phase and optionally a minor crystalline phase. The shaped article(s) may be a vitreous shaped article(s) or a glass ceramic shaped article(s). In other embodiments, the shaped particle(s) comprise at least 20 wt % amorphous phase.

It has been found that by increasing the amorphous component of shaped articles used in the formation of solid electrolytes, that the resultant solid electrolytes have improved ionic conductivity compared to the use of shaped articles which have a lower amorphous content. While not wanting to be limited by theory, it is thought that particles with a high amorphous content are able to transform into a crystalline state with less defects which inhibit ionic conductivity compared to the use of particles with lower amorphous content, which already have significant crystalline structure. It also has been found that lower temperatures and time may be used to transform high amorphous particles into the target cubic crystalline phase compared to lower amorphous containing particles. Thus, high amorphous particles are able to be processed with less energy and time, thereby making them suitable for large scale production. Advantageously, the high amorphous content particles may be transformed into the target morphology during the sintering of the shaped articles into a solid electrolyte (e.g. membrane), rather than the heat treating the shaped articles to form the target morphology prior to sintering the shaped articles into a solid electrolyte or electrode.

In some embodiments, the shaped article comprises a core shell configuration. The size of and composition of the particles combined with the quenching conditions may be used to control the proportion of core material to shell material. The core may be crystalline or amorphous. The shell may be crystalline or amorphous. In one embodiment, the shell is predominately amorphous and the core is predominately crystalline. In some embodiments, the shell of the core shell shaped article has a higher ionic conductivity than the core. In embodiments where the core has a higher conductivity than the shell, the core shell article may be milled to release particles with a defined ratio of amorphous and crystalline material.

The process may further include the step of separating the shaped articles by size. Air classification or screening techniques may be used for this purpose. As the morphology of the shaped articles may be influenced by the quenching process, then separating size fractions of the article population may result in an article population with a more uniform morphology. This may be particularly advantageous when the articles are used as an intermediate in the formation of a final product, where quality is dependent upon the size and/or morphology of the intermediate material.

In one embodiment, the shaped articles are separated by size into a target particle size range and an oversized range. The oversized range may be either reworked (e.g. remelted) or milled into the target particle size range. In some embodiments, the shaped particles comprise a mixture of spherical (unmilled) and non-spherical (milled) particles. Preferably, the mixture comprises at least 30 wt % or at least 40 wt % or at least 50 wt % or at least 60 wt % or at least 70 wt % or at least 80 wt % spherical articles (e.g. articles with a sphericity of at least 0.7). The mixture may comprise at least 1 wt % or at least 2 wt % or at least 5 wt % non-spherical particles.

In some embodiments, the average maximum distance between a central axis of the shaped article and the nearest (external) surface of the article is less than 10 mm (e.g. a sphere with a diameter of less than 20 mm) or less than 5 mm or less than 2 mm or less than 1 mm or less than 500 μm or less than 250 μm or less than 225 μm or less than 200 μm or less than 100 μm or less than 50 μm or less than 10 μm or less than 5.0 μm or less than 4.0 μm or less than 3.0 μm or less than 2.0 μm or less than 1.0 μm or less than 0.50 μm or less than 0.20 μm. The lower the maximum distance the higher the cooling rate at the core of the particle and the more uniform the morphology of the particle.

As the shaped articles are preferably melt derived, they are preferably glassy or vitreous in nature. The glassy/vitreous shaped article may be (i) an intermediate product in a process to be transformed into a different morphological form; or (ii) used as a component within a composite electrolyte (e.g. polymer composite electrolyte). Whilst the ionic conductivity of glassy electrolytes are generally considered to be lower than their crystalline counterparts, amorphous shaped articles have the advantages of (i) being more readily manufactured on a large scale; and (ii) being readily transformed into a target crystalline phase, if required. The shaped article(s) may have a stoichiometric composition:

L_{7+w-3x-z}M¹_{w}M²ₓG_{3-w}Zr_{2-y-z}M³_{y}M⁴_{z}O₁₂, Formula 1:

where
L is in each case independently a monovalent cation,
G is in each case independently a trivalent cation,
M¹=a divalent dopant,
M²=trivalent dopant
M³=tetravalent dopant
M⁴=pentavalent dopant
w, x, y, z are each in the range of 0 to <1.0
O can be partly or completely replaced by divalent or trivalent anions such as N³⁻.

In other embodiments, the ionic conductive shaped article may be a represented by the Formula 2 or 3.

Li₇₋ₓM¹ₓLa₃₋ₐM²ₐZr_{2-b}M³_{b}O₁₂ Formula 2

Li₇₋ₓLa₃₋ₐM²ₐZr_{2-b}M³_{b}O₁₂ Formula 3

wherein, in Formula 1, M¹ comprises at least one of gallium (Ga) and aluminum (Al), in Formulas 2 and 3, M² comprises at least one of calcium (Ca), strontium (Sr), cesium (Cs), and barium (Ba), M³ includes at least one of aluminum (Al), tungsten (W), niobium (Nb), and tantalum (Ta), and 0≤x<3, 0≤a≤3, and 0≤b<2.

In Formula 1, x may be from 0.01 to 2.1, for example, 0.01 to 0.99, for example, from 0.1 to 0.9, and from 0.2 to 0.8. In Formula 1, a may be from 0.1 to 2.8, for example, 0.5 to 2.75, and b may be from 0.1 to 1, for example, 0.25 to 0.5.

In the compound represented by the Formula 2, a dopant may be at least one of M¹, M², and M³. In the compound represented by the Formula 3 a dopant may be at least one of M² and M³.

The ionic conductive shaped articles may be derived metal sulphide glass, metal phosphate glass (e.g. LiTi₂(PO₄)₃), metal borate glass and/or metal silicate glass. The metals may include metals corresponding to metal ion battery chemistries and include magnesium, sodium, aluminium or lithium.

The ionic conductive shaped article composition is preferably a composition which forms crystalline phases or predominately crystalline phases without quenching of the molten mass.

In some embodiments, the sulfur-based glass is of a type Li₂S—YSₙ; Li₂S—YSₙ—YOₙ and combinations thereof, wherein Y is selected from the group consisting of Ge, Si, As, B, or P, and n=2, 3/2 or 5/2, and the glass is chemically and electrochemically compatible in contact with lithium metal. Suitable glass may comprise Li₂S and/or Li₂O as a glass modifier and one or more of a glass former selected from the group consisting of P₂S₅, P₂O₅, SiS₂, SiO₂, B₂S₃ and B₂O₃. In some embodiments, the glass may be devoid of phosphorous.

In some embodiments, the predominant glass former is SiO₂ (i.e. largest glass forming component is SiO₂). In some embodiments, the predominant glass former is SiS₂.

In some embodiments, no further heat treatment step(s) are required to transform the morphological form (e.g. amorphous and/or crystalline) after the quenching step.

Irrespective of the assigned valency of the dopant, the stoichiometric composition covers all dopants in all valency states. In particular, the dopant may be selected from the group consisting of Al, Ga, Ta, Nb, Zn, Mg, Sb, W, Mo, Rb, Sc, Ca, Sn, Bi, Ba, Sr, Zn, In, Y, Si, Ge, and Ce. For multivalent dopants, e.g. Mo where a valency state of 4+ has been assigned, the dopants may also exist into another valency state (e.g. Mo 6+). The dopant may comprise one or more dopants of the same or different valency states.

Therefore, the stoichiometric composition may alternatively be expressed by formula 4:

L_{q1}D_{q4}G_{q2}Zr_{q3}O₁₂,

where
L is in each case independently a monovalent cation,
G is in each case independently a trivalent cation,
D=is a dopant,
q1 is preferably in the range of 0 to 8 or higher
q2 is preferably in the range of 0 to 3
q3 is preferably in the range of 0 to 2
q4 is preferably in the range of 0 to 1
O can be partly or completely replaced by divalent or trivalent anions such as N³⁻,
   L is preferably selected from the group consisting of Li, Na and K. In a preferred embodiment L is Li. G is preferably La.

It has been unexpectedly found that the quenching of a molten mass of a stoichiometric composition of L_{7+w-3x-z}M¹_{w}M²ₓG_{3-w}Zr_{2-y-z}M³_{y}M⁴_{z}O₁₂ is able to produce shaped articles comprising an amorphous phase which is transformable into cubic crystalline form of L_{7+w-3x-z}M¹_{w}M²ₓG_{3-w}Zr_{2-y-z}M³_{y}M⁴_{z}O₁₂ during a densification process, preferably to form a membrane.

The densification process may be performed at an elevated temperature (e.g. at least 900° C. or at least 1000° C. or at least 1100° C.) and optionally under pressure. It has been found that the densification of a shaped article layer into a membrane may also transform the predominately amorphous shaped articles into a predominately crystalline membrane.

The use of predominately amorphous particles may also assist with achieving a high membrane density. The relatively density of the membrane may be at least 90% or at least 92% of at least 94% or at least 96% or at least 97% or at least 98%. In some embodiments, a residual amorphous content remains. The residual amorphous content is thought to lower interfacial resistance and therefore enhance membrane ionic conductivity relative to membranes formed by densification of predominately crystalline shaped articles.

In one embodiment, the shaped articles comprise a major amorphous phase and a minor cubic crystalline phase of L_{7+w-3x-z}M¹_{w}M²ₓG_{3-w}Zr_{2-y-z}M³_{y}M⁴_{z}O₁₂.

In one embodiment, the shaped article is a membrane. They membrane may be between about 5 μm and 500 μm. The process for forming a membrane may further include the steps of:
E. Forming the shaped articles into a layer;
F. Heat treating the layer to densify the layer; and
G. Maintaining the heat treatment for sufficient time to achieve a targeted morphology.

The membrane may also be formed under pressure to assist in the densification process and control the resultant morphology.

Heat treatment conditions may vary with the composition and morphology of the membrane. Guidance as to suitable heat treatment or sintering conditions may be found in Table 2.1 of Ramakumar et al, “Lithium garnets: Synthesis, structure, Li⁺ conductivity, Li⁺ dynamics and applications”; Progress in Material Science 88 (2017) 325-411, which is incorporated herein by reference.

In some embodiments, the shaped articles do not require any further destructive particle size reduction processes (e.g. ball milling), although screening or separation steps may be used to obtain the desired particle size fraction. The reduction or elimination of additional size reduction steps further simplifies the process. In embodiments, in which size reductions steps are taken, the size reduction factor (unmilled D50 particle size/milled D50 particle size) is preferably less than 100 or less than 50 or less than 25 or less than 10 or less than 5. The size reduction step (e.g. milling) may be performed immediately after the quenching step (i.e. before any heat treatment step).

The shaped articles may be formed into a layer through tape casting using a fugitive solvent as a carrier. In one embodiment, the shaped articles are formed using a solvent soluble inorganic binder solution, such as a lithium silicate solution.

In some embodiments, the shaped articles are platelets. Platelets are conducive to obtaining a uniform quenching rate and hence morphology. The use of platelets may also result in a membrane precursor layer with a reduced interfacial area between particles, which may result in lower interfacial resistance within the membrane. The platelets may have an average thickness of between 50 nm and 100 μm; and an aspect ratio of each of the minimum and maximum transverse dimension to thickness of 10:1 to 25,000:1.

In some embodiments, the aspect ratio of each of the minimum and maximum transverse dimension to thickness is in the range 110:1 to 25,000:1

In some embodiments, the aspect ratio of each of the minimum and maximum transverse dimension to thickness is in the range 200:1 to 25,000:1

The platelets may have an average thickness of between 50 nm and 1.0 μm. The platelets may comprise a minimum and maximum transverse dimension of at least 40 μm. In some embodiments, the maximum transverse dimension of the platelets may be at least 45 μm.

In some embodiments, further heat treatment steps are employed to transform a predominately amorphous LLZO phase into a predominately cubic crystalline LLZO phase.

In some embodiments, non-stoichiometric amounts of raw material components are used to form a non-stoichiometric melt which favour the formation of an amorphous phase. A non-stoichiometric melt is defined as a melt having the components of the stoichiometric composition, but not in the stoichiometric amounts to satisfy the crystal formula.

This simplified processing route is in contrast to the complex multiple step processes of the prior art in which the cubic crystalline phase is formed through solid state transformation mechanisms requiring multiple steps and prolonged periods at high temperatures.

The dopants may serve to stabilise a preferred crystalline phase or alternatively function as a crystallisation inhibitor to favour the formation of a shaped article with a high amorphous content.

In some embodiments, the shaped article(s) comprises at least 60 wt % amorphous material or at least 70 wt % amorphous material or at least 80 wt % amorphous material or at least 90 wt % amorphous material or at least 95 wt % amorphous material or at least 98 wt % amorphous material. In some embodiments, the shaped article(s) comprises no more than 98 wt % or no more than 90 wt % or no more than 80 wt % amorphous material. The shaped article may comprise less than 50 wt % or less than 40 wt % or less than 30 wt % or less than 20 wt % or less than 10 wt % material of a first crystalline form (e.g. garnet-like cubic crystalline form). The shaped article may comprise less than 30 wt % or less than 20 wt % or less than 10 wt % or less than 5 wt % material in a second crystalline form (e.g. garnet-like tetragonal crystalline form. The amount of the first crystalline form is preferably greater than the second crystalline form. In a preferred embodiment, no second crystalline form is detected via XRD. The shaped article(s) may comprise greater than 0 wt % or at least 5 wt % or at least 10 wt % or at least 15 wt % or at least 20 wt % crystalline material or at least 25 wt % crystalline material or at least 30 wt % crystalline material.

The shaped articles may comprise an amorphous or vitreous surface. Whilst the ionic conductivity of the crystalline phase may have a higher ionic conductivity, the advantage of large scale manufacturability of predominately amorphous shaped articles is sufficient to balance any decrease in ionic conductivity. Further, the formation of an amorphous phase assists in the reduction in interfacial resistance to ionic conductivity.

The raw material is preferably melted to a temperature sufficient to melt the raw materials to above the melting temperature of the target composition and crystalline form thereof (i.e. cubic crystalline form of the garnet-like material). The melting vessel may operate above 800° C. or at least 900° C. or at least 1000° C. or at least 1100° C. or at least 1200° C. or at least 1300° C. or at least 1400° C. The maximum operating temperature may be limited by the temperature at which the composition decomposes (e.g. into La₂Zr₂O₇ and Li₂ZrO₃).

A cooling medium is preferably used to quench the molten mass. The cooling medium may be a fluid (gas or liquid) stream and/or a moving object (e.g. spinning wheel, or roller).

The average quenching rate is at least 50° C. per second or at least 100° C. per second or at least 200° C. per second or at least 400° C. per second or at least 500° C. per second or at least 600° C. per second or at least 800° C. per second or at least 1000° C. per second or at least 1500° C. per second or at least 2000° C. per second or at least 4000° C. per second or at least 6000° C. per second or at least 10,000° C. per second between the time the molten mass contacts the cooling medium and the solidification of the molten mass.

In one embodiment, the average temperature differential between the molten mass and cooling medium while the molten mass is in contact with the cooling medium is at least 200° C. or at least 300° C. or at least 400° C. or at least 500° C. or at least 600° C. or at least 700° C.

Preferably, the molten mass is shaped prior to being quenched. Through shaping the molten mass, the maximum distance between a central axis of a particle and the particle's surface can be controlled to enable rapid cooling across the majority or the entirety of the shaped mass. Additionally, through shaping the molten mass to dimensions which require little if no further processing to reduce its size for end-use application (e.g. in an electrolyte system in a battery), then there is not the propensity of the crystalline phase to change from the preferred cubic form during size reduction operations, such as milling or grinding. Additional contamination of the material may also be avoided through minimising additional processing steps.

However, the process may include grinding and milling steps where additional size reduction is required. The additional size reduction steps may be conducted in an inert fluid (gaseous or liquid (e.g. water or anhydrous organic solvents) to avoid surface contamination or the formation of contaminants.

The process may further include washing steps or surface treatment steps to remove contaminants from the surface and/or treat the surface to enhance the surface properties (i.e. functionalise or alter surface morphology (e.g. surface area or porosity) to enable, for example, improved contact with a polymer, when the shaped articles are part of a polymer composite).

Quenching is dependent upon a rapid decrease in temperature across the molten mass to result in solidification without enabling the crystalline structure the time to reorder into a more thermodynamically stable structure at the quenched temperature. It will be appreciated that a number of factors will influence the quenching process which enables this effect to be achieved including, but not limited to:
shape of the molten material;
temperature of the molten material and the cooling medium used to quench it;
the surface area to volume ratio of the molten material
maximum distance between a central axis and a surface of the molten mass;
the heat capacity and conductivity of the molten mass and the cooling medium; and
the volume of cooling medium and its movement relative to the molten mass

The shaped mass may comprise particles (of various shapes including spherical or spherical like), films or fibres. In embodiments wherein the particles are spherical or spherical-like, the sphericity factor of the particles may be at least 0.6 or at least 0.7 or at least 0.8 or at least 0.9. Sphericity is defined as the ratio of the surface area of a sphere of equal volume to the surface area of the particle:

(π^{1/3}(6Vₚ)^{2/3}/Aₚ)

where Vₚ denotes the volume of the particle and Aₚ its surface area.

Spherical particles may be formed through the avoidance of additional comminution steps are the initial shaping of the molten material. Spherical particles have the advantage of providing uniform processing characteristics, which minimises internal stresses during heating the cooling operations (e.g. during membrane formation). Particles which have been milled tend to have a greater degree of geometric irregularity and a higher specific surface area compared to spherical particles directly shaped from the molten mass.

In some embodiments, the shaped articles may comprise one or more shapes (e.g. platelets and particles); comprise one or more compositions and/or comprise one or more crystalline structures.

Due to variations in the dimensions of the shaped mass, to obtain the required level of amorphous or crystallinity (e.g. cubic LLZO) the shaped mass may need to be separated on the basis of size or shape to separate out the shaped mass with predominantly a cubic crystalline structure. Separation techniques may include sieving, air classification or the like.

In some embodiments, the combination of the cooling rate and the dimensions of the particles are sufficient to form a predominantly amorphous form of L₇₊ₓAₓG₃₋ₓZr₂O₁₂, such as doped lithium lanthanum zirconium oxide.

In some embodiments, the shaped articles comprise an average maximum cross-sectional dimension of less than 50 mm or less than 20mm or less than 10 mm or less than 1 mm or less than 500 μm or less than 250 μm or less than 100 μm or less than 50 μm or less than 10 μm or less than 5.0 μm or less than 4.0 μm or less than 3.0 μm or less than 2.0 μm or less than 1.0 μm. The average minimum cross-sectional dimension may be 50 nm or more or 100 nm or more or 200 nm or more or 500 nm or more. In other embodiments, wherein the shaped article comprises a film or sheet, the maximum cross-sectional dimension may in the range of 100 mm to 1.0 m.

In some embodiments, including those illustrated in FIG. 2, some of the particles comprise a diameter of about 2 μm and about 3 μm and about 4 μm and about 5 μm at the smaller end of the range. At the larger end of the range, some particles may comprise a diameter of about 20 μm and about 30 μm and about 40 μm. In some embodiments, the particles comprise a diameter in the range of 3 μm to 40 μm or 4 μm to 30 μm or 5 μm to 20 μm.

In some embodiments, the particle size distribution has an average or median (D50) particle size of greater than 600 nm or greater than 700 nm or greater than 800 nm or greater than 900 nm or greater than 1.0 μm or greater than 1.1 μm or greater than 1.2 μm or greater than 1.3 μm or greater than 1.4 μm or greater than 1.5 μm or greater than 1.6 μm or greater than 1.7 μm or greater than 1.8 μm or greater than 1.9 μm or greater than 2.0 μm or greater than 2.5 μm or greater than 3.0 μm or greater than 3.5 μm or greater than 4.0 μm or greater than 4.5 μm or greater than 5.0 μm or greater than 6.0 μm or greater than 7.0 μm. In some embodiments, the particle size distribution of the particles has an average or D50 of less than 500 μm or less than 450 μm or less than 400 μm or less than 300 μm or less than 200 pm or less than 150 μm or less than 120 μm or less than 100 μm or less than 80 μm or less than 60 μm or less than 50 μm or less than 40 μm or less than 30 μm or less than 20 μm or less than 18 μm or less than 16 μm or less than 14 μm or less than 12 μm or less than 10 pm or less than 8.0 μm or less than 6.0 μm or less than 4.0 μm or less than 2.0 μm or less than 1.0 μm. The D10 may be greater or equal to D50/4. The D90 may be less or equal to D50*4.

In a preferred embodiment, the average or D50 of the shaped particles is in the range of 600 nm to 20 μm and preferably in the range 600 nm to 10 μm. Particles within this range may require no or minimal comminution steps (e.g. one or two steps) prior to be transformed into a solid electrolyte.

In another embodiment, the average or D50 of the shaped particles is in the range of 600 nm to 2.0 μm. Particles within this range may not require further comminution steps prior to be transformed into a solid electrolyte.

In a preferred embodiment, the molten mass is simultaneously quenched and shaped. This may be achieved through a cooling medium impinging on the molten mass both to reduce the size of the shaped molten mass and to provide rapid cooling to produce the resultant solidified shaped mass. In another embodiment, the shaping process occurs at a high temperature (e.g. greater than 900° C. or greater than 1000° C. or greater than 1200° C. or greater than 1300° C. or greater than 1400° C.), with the shaped material still in a molten form. Higher shaping temperatures are favourable to smaller shaped mass formation as the viscosity of the molten liquid mass is lower at higher temperature.

The doped lithium lanthanum zirconium oxide is preferably represented by one of the following formulas:

Li_{7+w}La₃₋₁M¹_{w}Zr₂O₁₂ Formula 5:

where 0<w<0.6 or <1.0, and M¹=divalent dopant, e.g. Ca, Sr, Ba

Li₇₋₃ₓM²ₓLa₃Zr₂O₁₂ Formula 6:

where 0<x<0.6 or <1.0, and M²=trivalent dopant, e.g. Al, Ga

Li₇La₃Zr_{2-y}M³_{y}O₁₂ Formula 7:

where 0<y<0.6 or <1.0, and M³=tetravalent dopant, e.g. Mo, Ce, W

Li_{7-z}La₃Zr_{2-z}M⁴_{z}O₂ Formula 8:

where 0<z<0.6 or <1.0, and M⁴=pentavalent dopant, e.g. Ta

In some embodiments, the stoichiometric composition comprises or consists of lithium lanthanum zirconium oxide (Li₇La₃Zr₂O₁₂ with w+x+y+z=0). In some embodiments, the stoichiometric composition comprises or consists of a doped lithium lanthanum zirconium oxide (w+x+y+z>0).

The level of dopant is preferably sufficient to stabilise the cubic crystalline phase. The level of dopant may vary, but is generally such that 0<w+x+y+z< or 2.0 or 0.05<w+x+y+z<1.0 or 0.1<w+x+y+z<0.8 or 0.2<w+x+y+z<0.6. Dopant levels of at least 0.05 or at least 0.1 or at least 0.2 may be required to stabilise the cubic crystalline structure during the quenching process. In some embodiments w=0.

The dopant is preferably selected from the group comprising Al, Ga, Ta, Nb, Zn, Mg, Sb, W, Mo, Rb, Sc, Ca, Sn, Bi, Ba, Sr, Zn, In, Y, Si, Ge, and Ce.

In one embodiment the dopant comprises Al and/or Mo.

Preferably, w, x, y and/or z is greater than 0.02 or greater than 0.05 or greater than 0.1 or greater than 0.2 or greater than 0.3.

In one embodiment, x is in the range 0.1 to 1.0 or 0.2 to 0.8 or 0.3 to 0.6. In one embodiment, M²=Al. In another embodiment, the dopant M⁴ comprises or consists of Ta.

In one embodiment, the dopant is provided to the melting vessel via a sacrificial electrode, such as in an electric arc furnace. The electrodes used in electrical furnaces are susceptible to erosion in the operating environment.

The amount of dopant derived from the sacrificial electrode may be controlled through one or more of:
a. the temperature of the melting vessel;
b. distance between electrode tips
c. electrode settings (voltage and amperage)
d. the exposure of the sacrificial electrode to an oxygen containing environment;
e. the surface area of the sacrificial electrode in contact with the molten mass;
f. the composition of the sacrificial electrode;
g. the composition of the molten mass; and
h. residence time in the melting vessel

In some embodiments, the dopant provided via the sacrificial electrode is Mo and/or W. In some embodiments, the dopant is partly provided from the sacrificial electrode. The remaining dopant may be added as part of the raw material mix.

In alternative embodiments, the dopants are entirely sourced from the raw material.

In a second aspect of the present disclosure, there is provided a product produced (obtained or obtainable) by a process according to the first aspect of the present disclosure.

In one embodiment, the article forms part of a polymer composite electrolyte comprising a polymer and said articles. The composite electrolyte may comprise in the range of 2 wt % and 98 wt % of the articles or in the range of 5 wt % and 60 wt % of the articles or at least 10 wt % and 40 wt % of the articles. Suitable polymers include, but are not limited to, polyvinylidene fluoride (PVDF), poly (vinylidene fluoride-hexafluoropropylene) (PVDF-HFP)), Polyphenylene sulphide (PPS), polymethyl methacrylate (PMMA), polyacrylonitrile (PAN), polyimide (PI), polyvinyl pyrrolidone (PVP), polyethylene oxide (PEO), polyvinyl alcohol (PVA), polylactic acid (PLA), polysaccharides (for example carboxymethyl cellulose (CMC)), styrene-butadiene rubber (SBR) and derivative and combinations thereof.

The articles may have an ion conductivity (grain or total) at 30° C. or room temperature of at least 1.0×10⁻⁶ S cm⁻¹ or 5.0×10⁻⁶ S cm⁻¹ or 6.0×10⁻⁶ S cm⁻¹ or 7.0×10⁻⁶ S cm⁻¹ or 8.0×10⁻⁶ S cm⁻¹ or 9.0×10⁻⁶ S cm⁻¹ or 1.0×10⁻⁵ S cm⁻¹ or 1.2×10⁻⁵ S cm⁻¹ or 1.4×10⁻⁵ S cm⁻¹ or 1.5×10⁻⁵ S cm⁻¹ or 2.0×10⁻⁵ S cm⁻¹, or 3.0×10⁻⁵ S cm⁻¹ or 4.0×10⁻⁵ S cm⁻¹ or 5×10⁻⁵ S cm⁻¹, or 1×10⁻⁴ S cm⁻¹ or 5.0×10⁻⁴ S cm⁻¹ or 1.0×10⁻³ S cm⁻¹.

Grain conductivity (σ_{g}) of a material relates to the ionic conductivity through a single grain or crystallite and is dependent on multiple factors, including but not limited to the composition, crystallinity and temperature.

In a third aspect of the present invention there is provided a shaped article (preferably vitreous) comprising an ionically conductive composition, wherein the average maximum distance between a central axis of the shaped article and a nearest surface is no greater than 10.0 mm (or no greater than 250 μm and greater than 600 nm) and wherein the shaped article comprises at least 50 wt % or at least 60 wt % or at least 70 wt % amorphous phase.

In a variation of this aspect, there is provided vitreous particles comprising a garnet-like, a perovskite-like or a spinel-like composition, wherein particle size D50 is in the range of 600 nm (or 800 nm or 1000 nm) to 20 μm; the sphericity is 0.7 or greater; and the particles comprise at least 50 wt % amorphous phase.

Particles within this size range are particularly suitable for the formation of solid electrolytes, including membranes for use in energy storage devices, such as lithium batteries. Larger particles require additional comminution steps to reach the target PSD. Additionally, to obtain the higher amorphous contents, greater quenching means are required in terms of the quenching mediums temperature and/or heat capacity. Whilst, smaller particles are more difficult to handle and process on a large scale.

The average maximum distance between the central axis of the shaped article and the nearest surface may no greater than 5.0 mm or no greater than 1.0 mm or no greater than 500 μm or no greater than 450 μm or no greater than 400 μm or no greater than 350 μm or no greater than 300 μm or no greater than 250 μm or no greater than 225 μm or no greater than 200 μm or no greater than 150 μm or no greater than 100 μm or no greater than 90 μm or no greater than 80 μm or no greater than 70 μm or no greater than 60 μm or no greater than 50 μm or no greater than 40 μm or no greater than 30 μm or no greater than 25 μm or no greater than 20 μm or no greater than 15 μm or no greater than 10 μm or no greater than 9.0 μm or no greater than 7.0 μm or no greater than 5.0 μm or no greater than 4.0 μm or no greater than 3.0 μm or no greater than 2.0 μm. The larger the distance between the central axis and the nearest surface the greater the amount of energy which needs to be drawn from the particles to quench them in sufficient time to maintain the preferred amorphous content, e.g. at least 50 wt % amorphous material. The balance between scalability, cost and the required level of amorphous material will influence the selected parameters for a given application.

The ionically conductive composition is preferably a garnet-like crystal forming composition perovskite-like crystal forming composition or a spinel-like crystal forming composition.

The shaped article may comprise the technical features previously described in the first aspect of the present invention.

In a fourth aspect of the present invention there is provided an ionically conductive membrane intermediate comprising a layer of shaped articles of the third aspect of the present invention.

The layer may be a precursor to the whole of the membrane or one of a plurality of layers in the membrane. In one embodiment, the layer is positioned on one of the outside layers of the membrane. In another embodiment, a layer is positioned on each outer layer of the membrane. The middle layer may comprise or substantially consists of a crystalline phase. In some embodiments, a middle layer comprises or substantially consists of a cubic garnet-like crystalline phase.

In a fifth aspect of the present invention, there is provided the use of shaped articles of the third aspect for the manufacture of a solid electrolyte.

In a sixth aspect of the present invention, there is provide a composite material comprising a solvent soluble inorganic binder matrix comprising:
a solvent soluble inorganic binder; and
a plurality of ionically conductive particles;
   wherein the ionically conductive particles are present in a range from 20 wt % to 99.5 wt % based upon the total weight of the ionically conductive particles and the solvent soluble inorganic binder.

The ionic conductive particles may be crystalline, semi-crystalline or amorphous.

A solvent soluble inorganic binder may be used to form a membrane with the solvent being removed after the formation of the membrane (e.g. by drying/sintering). In some embodiments, the inorganic binder is a water soluble inorganic binder. The water soluble binder may be a water glass (e.g. sodium, potassium or lithium silicate). In a preferred embodiment, the water soluble inorganic binder is lithium silicate. The use of the water soluble binder may be a means to densify the membrane under lower temperatures and shorter sintering times.

In some embodiment, the membrane comprises in the range of 1 wt % to 40 wt %; or 2 wt % to 20 wt %; or 3 wt % to 10 wt %; of said inorganic binder.

Reference to LLZO should be construed as encompassing doped LLZO unless the context clearly indicates otherwise.

Reference to vitreous shaped articles (e.g. particles) should be construed as encompassing reference to glassy or glass-ceramic or melt formed shaped articles.

Reference to an ionic conductivity phase means a phase comprising an ionic conductivity of at least of 1.0×10⁻⁶ S cm⁻¹ or at least 1.0×10⁻⁵ S cm⁻¹ at 30° C. or room temperature.

Reference to a major phase is reference to the phase representing the highest proportion (% wt) of the composition.

For the purpose of the invention, garnet-like encompasses garnet-like crystalline phases and amorphous phases capable of transforming into a garnet-like crystalline phase.

The nearest surface to the central axis is preferably at right angles to the central axis. The measurement is preferably taken away from the periphery of the article

Predominant for the purposes of the invention means at least 50 wt %.

Garnet-like crystal forming (or garnet-like) compositions are defined as compositions that correspond to or approximate the stoichiometric compositions of garnet or garnet-like crystals, such as cubic LLZO structures or doped variations thereof. Representative garnet-like compositions are provided in Formulas 1-8.

Perovskite-like crystal forming (or perovskite-like) compositions are defined as compositions that correspond to or approximate the stoichiometric compositions of perovskite (e.g. Li₃ₓLa_{2/3x}TiO₃) or perovskite-like crystals, such as LLTO crystalline structures or doped variations thereof, including lithium rich (e.g. La_{0.5}Li_{O.5}TiO₃) and poor stoichiometries (e.g. La_{0.56}Li_{O.33}TiO₃).

Spinel-like crystal forming (or spinel-like) compositions are defined as compositions that correspond to or approximate the stoichiometric compositions of spinel (e.g. Li₄Ti₅O₁₂) or spinel-like crystals including doped variations thereof.

For the purposes of the present invention a water or solvent soluble inorganic binder will be inclusive of inorganic binder which are soluble in water at room temperature or that form a colloidal solution at room temperature.

For clarity, the nearest surface of a central axis of an article is the nearest external surface.

For the purposes of the present invention, a central axis of an article is a central axis running parallel to the longest 2D plane of the article. As such, the distance between the central axis and the nearest surface corresponds to the distance between a quenching medium and the central axis. This parameter will affect time required to quench the material along the central axis.

The D50 is the size in microns that splits the distribution with half of particles above and half of particles below this diameter. The D50 calculation, unless otherwise indicated, is determined from laser diffraction techniques using a Malvern Panalytical Morphologi 4 running Morpholigi ID, version 10.32 software. The sphericity of the particles was also determined via this equipment. A sample size of approximately 20 mg was used.

Average particle dimensions may be calculated from a sample population of at least 20 and preferably at least 50 or at least 100 or at least 500 particles. Particle size dimension may be carried out using Scandium™ 5.1 software.

Sieve size fraction means the particle size fraction corresponding to the sieve size(s) which the particles fit through after sieving. A 40 μm-180 μm sieve size fraction corresponds to particles which fit through a 180 μm sieve, but do not fit through a 40 μm sieve.

### BRIEF DESCRIPTION OF THE FIGURE

FIG. 1 is a schematic diagram of the apparatus used to produce the shaped articles according to a process of the present disclosure.

FIG. 2 is an SEM image of shaped articles prepared using the apparatus of FIG. 1.

FIG. 3 is a SEM image of a core shell shaped article prepared using the apparatus of FIG. 1.

FIG. 4 is an XRD diffractogram of a shaped article size population prepared using the apparatus of FIG. 1.

FIG. 5 is an XRD diffractogram of a membrane formed from sintering the shaped articles of FIG. 2.

FIG. 6 is a SEM image of Sample 1703 from Table 1.

FIG. 7 is a SEM image of Sample 1703 from Table 1 after being roll milled.

FIG. 8 is an SEM image of a membrane formed from the sintering of Sample 1A.

FIG. 9 is an SEM image of a membrane formed from the sintering of Sample 1B.

FIG. 10 is an SEM image of a membrane formed from the sintering of Sample 1C.

FIG. 11 is an SEM image of spherical particles of LTO produced in Example 5.

FIG. 12 is a galvanostatic charge discharge plot of the LTO produced in Example 5.

FIG. 13 is an SEM image of spherical particles of LLTO produced in Example 6.

FIG. 14 is a magnified SEM image of the surface morphology of the spherical particles of LLTO produced in Example 6.

### DETAILED DESCRIPTION OF A PREFERRED EMBODIMENT

### Forming the Melt

The raw materials are preferably provided in stoichiometric oxide form. Due to the volatility of some components, such as lithium, excess amounts may be required to achieve the desired stoichiometric quantities in the final product.

Hydroxide, hydrate and carbonate forms may also be used, as the gaseous reaction products are generally non-toxic. Nitrates, sulphates and other salts are less preferred due to the formation of toxic gases and the requirement to provide a washing step to remove impurities from the garnet-like final product.

Any suitable melting vessel may be used which is able to melt the raw materials to form a molten mass which can then be drawn out at a controlled rate through a discharge opening to enable the material stream to be shaped and quenched. A nozzle may be used to control the flow rate exiting the melting vessel. Electrical furnaces, such as an arc furnace, may be used. The temperature of the molten mass may be determined by the temperature required to produce the desired shaped fibres, sheets or particles.

The melting step may be conducted on a batch, semi-batch or continuous basis, heating the raw materials up to above the melting point of the raw material components and that of the stoichiometric composition being targeted. Operating under continuous conditions requires a plug like flow regime to ensure that the raw material is exposed to a minimum residence time to avoid variations in the molten material exiting the vessel. The inlet of the furnace is preferably protected from the ingress of contaminants. An inert gas to blanket the exposed melt may also be used.

The molten material may be blanketed in a controlled atmosphere such as air, hydrogen, helium or other gases prior to shaping and/or quenching. The purpose of the controlled atmosphere may include blocking chemical reaction or controlling surface tension.

### Shaped Material Formation

In general, the shaping process, apart from particle formation through fluid impingement or other simultaneous quenching and shaping techniques, requires a sufficient temperature to be maintained to form the required shape and dimensions from the molten mass. As such, the shaping step is usually conducted at a similar temperature to that of the molten mass leaving the melting vessel (e.g. less than 200° C. or less than 100° C. difference). As a result, the shaping device is typically located within 1 m or within 0.5 m of the melting vessel outlet.

### Fibres

Fibres are defined as having a length to diameter ratio of at least 3. The fibres may be advantageously produced by various techniques as known in the art, including but not limited to melt spinning or blowing techniques to produce fibres with an arithmetic average diameter of less than 10.0 μm, preferably less than 5.0 μm and even more preferably less than 2.0 μm. Extra fine fibre diameters can be achieved using high speed spinning techniques as disclosed by the applicant in WO2017121770.

The fibre forming temperatures of molten material are similar to other particles formed or shaped using rotating or spinning devices.

### Particles

Particles may be formed through exposing a stream of molten material to a fluid stream which simultaneously quenches and forms particles (e.g. amorphous and garnet-like crystalline material). Through varying the pressure and impingement angle of the fluid stream, mean particle sizes of less than 2 μm are achievable. Pressure of the fluid medium may be in the range of 1 atm. to 50 atm. or in the range 2 atm. to 20 atm. or in the range 3 atm. to 10 atm. In some embodiments, the fluid pressure is at least 4 atm. or at least 5 atm. The impingement against a hotter molten mass, with a lower viscosity, may result in even lower mean particle sizes, which in some embodiment may reach into the sub-micron region.

The particles may be non-porous.

The molten mass may initially form droplets prior to the undergoing fluid impingement. Droplet formation may be achieved, by those skilled in the art, through adjusting the flowrate and/or outlet diameter of the molten mass or through disrupting the molten mass flow. A two-step particle size reduction process favours a more consistent and finer particle size distribution.

Screening and air classification techniques may be used to produce particles with a lower mean particle size (e.g. less than 1.5 μm or less than 1.0 μm).

PSDs with a D50 of about 500 nm or less may be manufactured but become more difficult to handle in the manufacturing process and scaling up of the manufacturing process becomes more difficult.

In some embodiments, the fluid stream may be liquid. In such embodiments, it may be sufficient for the molten material to be passed through a nozzle and into a body of liquid for sufficient quenching to occur.

### Film

A stream of molten material may be passed between two rotating rollers to produce a thin film of molten material which then may be passed through a quenching chamber comprising a cooling medium. In one embodiment (as illustrated in the Journal of Physique; Yoshiyagawa and Tomozawa; 1982, 43, ppC9-411-C9-414) a stream of molten material is processed by twin rollers to produce a thin film (<100 μm thickness) before being immersed into a liquid nitrogen bath resulting in a cooling rate in the order of 10⁵° C./second.

### Platelets

WO1988008412 (incorporated herein by reference) discloses an apparatus and a method of producing platelets from a molten material through feeding a stream of molten material in a downwards direction into a rotating cup. Details of the apparatus and operating conditions to form the platelets are provided in WO2004/056716, EP0289240 and U.S. Pat. No. 8,796,556, which are incorporated herein by reference.

### Quenching

Prior or during quenching, the molten material is preferably shaped into sufficiently small enough dimensions to enable rapid cooling throughout the molten material to generate a target crystalline structure (e.g. a predominately cubic crystalline structure for garnet like compositions) in the final product. It will be appreciated that the required dimensions of the shaped material will be dependent upon the heat transfer properties (including the temperature, heat capacity and conductivity) of the cooling medium as well as the shaped material. Routine experimentation may be required to optimise the quenching and material shaping processes to obtain the desired level of amorphous and target crystalline material.

In one embodiment, the molten material preferably flows through a quenching chamber. The quenching chamber comprises:
(A) a first inlet for receiving the glass ceramic material from the shaping device (e.g.

compressed gaseous jet, spinning wheel or twin rollers);
(B) a second inlet for receiving a cooling medium stream; and
(C) an outlet for the outputting of the quenched glass ceramic material from the quenching chamber.

The cooling medium may be a fluid. The fluid may be a gas or a liquid. Alternatively, the cooling medium may comprise a solid surface.

Quenching may be accomplished using inert gases, such as nitrogen and noble gases. Nitrogen is commonly used at greater than atmospheric pressure ranging up to 20 bar absolute. Helium is also used because its thermal capacity is greater than nitrogen. Alternatively, argon can be used; however, its density requires significantly more energy to move, and its thermal capacity is less than the alternatives. The gases are preferably compressed gases. The use of inert gases reduces the likelihood that the quenching process contributes to the formation of impurities, which may affect the functionality of the final product. Air may also be used if the quality of the final product is not detrimentally affected for the desired end-use application.

Alternatively, the cooling medium may be a liquid, including water or liquid nitrogen. Liquids such as water have the disadvantage of potentially reacting with the molten mass or shaped articles. Additionally, additional steps may be required to remove a cooling medium, such as water. In some embodiments, the process does not include water as a cooling medium and/or grinding medium.

According to various embodiments, the fluid stream can have a temperature ranging from about room temperature to about −200° C., from about 10° C. to about −100° C., from about 0° C. to about −60° C., or from about −10° C. to about −50° C., including all ranges and subranges therebetween. The velocity of the compressed fluid stream may range for example, from about 0.5 m s⁻¹ to about 2000 m s⁻¹, such as from about 1 m s⁻¹ to about 1000 m s⁻¹, from about 2 m s⁻¹ to about 100 m s⁻¹, from about 5 m s⁻¹ to about 20 m s⁻¹, or from about 5 m s⁻¹ to about 15 m s⁻¹, including all ranges and subranges therebetween. In some embodiments, the fluid stream velocity is at least 100 m s⁻¹ or at least 150 m s⁻¹ or at least 200 m s⁻¹ or at least 250 m s⁻¹ or at least 300 m s⁻¹ or at least 350 m s⁻¹. The fluid stream velocity may be taken at the point of impingement or at the exit point of the device emitting the fluid stream. It is within the ability of one skilled in the art to select the stream velocity appropriate for the desired operation and result.

The glass ceramic can thus be rapidly cooled to a temperature below its solidification point, e.g., a temperature less than about 600° C., such as less than about 575° C., less than about 550° C., less than about 525° C., or less than about 500° C. In certain embodiments, the glass ceramic can be rapidly cooled to a temperature ranging from about 200° C. to about 600° C., from about 250° C. to about 500° C., or from about 300° C. to about 400° C., including all ranges and subranges therebetween.

According to various embodiments, the term “rapid cooling”, “quenching” and variations thereof is used to denote cooling of the glass ceramic to at least its solidification temperature (and preferably less than 200° C. or less than 150° C.) within a period of time sufficient to form and stabilise the desired amorphous and/or target (e.g.cubic) crystalline structure. According to various embodiments, the time period may be less than about 10 seconds, for instance, less than about 5.0 seconds, less than about 4.0 seconds, less than about 2.0 seconds, or less than about 1.0 second, although longer or shorter time periods are possible and intended to fall within the scope of the disclosure. In other embodiments, the rapid cooling may occur within the time period from about 0.1 to about 0.9 seconds.

In one embodiment, the quenching process comprises the step of feeding a stream of molten mass into a quenching chamber, said quenching chamber comprises:
an inlet for admitting a stream of molten mass to enter the vessel;
a means for the molten mass and a fluid cooling medium to impact to thereby atomise the molten mass into particles.

Atomisation may be achieved through impinging a fluid cooling medium upon the molten mass or through impinging the molten mass upon the fluid cooling medium. For reasons of safety, the former arrangement is preferred.

In one embodiment, at least one nozzle arranged to direct a pressure jet of a fluid cooling medium to impinge upon the stream of molten mass causing the molten mass stream to atomise into particles.

In some embodiment, the quenching and shaping of the particles is achieved by the fluid impingement of the cooling fluid medium. The cooling medium may be an inert gas, such as nitrogen. The cooling medium is preferably cooled to below ambient temperature and recirculated back into the chamber after passing through a heat exchanger (e.g. chiller). The quenching chamber may comprise inert gases at a positive pressure to prevent the ingress of air into the chamber. The quenching chamber may be positioned vertically below the melting vessel with the atomised particles falling under gravity to the bottom of the vessel.

The height of the quenching vessel is preferably such that atomised particles are solidified prior to reaching the bottom of the vessel.

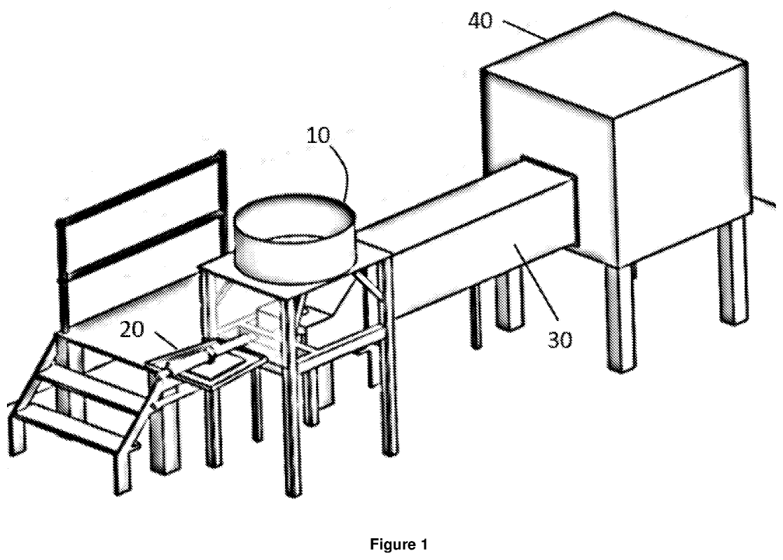

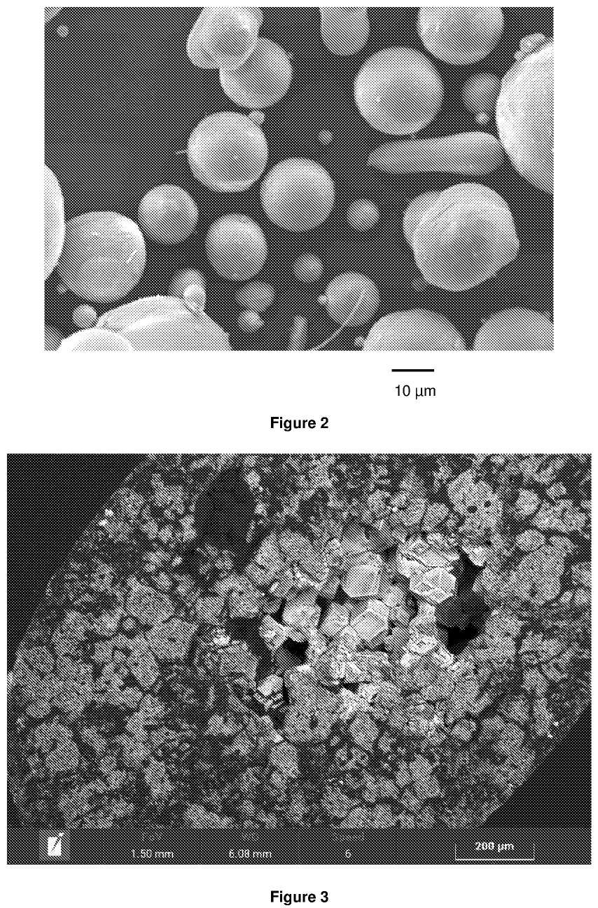

In one embodiment, the melting vessel, quenching chamber and material transport units are configured as disclosed in FIG. 1 or 2 (and associated text) of GB1340861 which is incorporated herein by reference.

As indicated in GB1340861 some embodiments may include:
producing a flow of molten material in a volume of cooling gas, directing at least one fluid jet from a nozzle to intersect the flow to atomize the molten material to form drops, causing by venturi action a reduction of pressure at a position at or near to the or each intersection of the or each jet and flow, allowing the drops to solidify by movement through the gas, and inducing, by the reduced pressure, recirculation of the gas along a cooling passageway joining a position downstream of the or each intersection with the position of reduced pressure. The combined jet and molten material flow may be is passed through a constricted passageway to induce the venturi action;
several jets of atomising agent aimed to form several sides of the molten steam so that all the jets intersect each other at substantially the same point;
the cooling medium being continuously cooled by being circulated through a heat exchanger;
the solidified particles slipping or sliding along an inclined cooling surface where the final cooling takes place. The inclined surfaces reduce the risk of the particles deforming form interaction with the inclined surface. Cooling may take place until there is no risk of the particles sticking together or being deformed. The cooled particles are collected at an outlet;
A first fluid jet forces a stream of molten material to alter direction and also to a certain extent, splits the melt in the stream of molten material into drops. The stream of molten material is then intersected by a second fluid jet from the nozzle at such a distance from the intersection between the stream of molten material and the first fluid jet that most of the molten material has time to alter direction. The second jet, which is substantially parallel to the original direction of the tapping stream, completes the separation of the molten material into drops and spreads this as a shower in the chamber;
Use of a fluidized bed at the bottom of the quenching chamber to cool the particles; and
The fluid jet and the cooling gas comprise the same inert gas.

It will be understood that in the abovementioned quenching vessel, the pressure jets may be replaced or complemented with other shaping forming devices, such as rotating cup (platelet formation) or twin rollers (film formation).

### EXAMPLE 1

Stoichiometric quantities of Al₂O₃ (dopant), La₂O₃ and ZrO₂ were combined with 20% stoichiometric excess of Li₂CO₃ to form a powdered mixture which was added to the melt rig. A small amount of Mo dopant was provisioned to be added from the molybdenum electrodes used in the melt rig. The quantity of Mo added via the electrodes was calculated from levels of Mo added to previous batches operated at similar operating conditions.

The melt rig (FIG. 1) comprises a cylindrical water-cooled stainless-steel vessel 10 having an internal diameter of 340 mm and an internal height of 160 mm. The melt rig comprised of two molybdenum electrodes (not shown) which were submerged in the powdered mixture with the electrode tips being approximately 5 mm apart. An alumina plate was positioned at the bottom of the rig, with an alumina rod covering a 14 mm orifice which functioned as a discharge opening.

The mixture was manually fed into the vessel 10 from an opening at the top, with an exhaust fan used to remove gases generated. The mixture was initially heated using an oxyacetylene torch to melt a small pool, at which point the electrodes were powered to form a current between them. The power was increased slowly over 30-45 minutes and the electrodes were moved further apart to build a larger melt pool within the furnace with the temperature of the melt pool being >1250° C.-1500° C. Batch process conditions were used, with the total residence time of the melt pool, once formed, not exceeding 1 hour.

When the melt pool was sufficiently large, the alumina rod was removed from the plate instantly releasing the melt pool through the 14 mm orifice to form a molten stream, with an approximate mass flowrate of 250 kg/hr. The molten stream travelled approximately 500 mm in about 0.05 seconds before being impacted by an air stream (6 bar, 7° C.,˜0.114 m³ s⁻¹) from an air gun 20 which simultaneously shaped the molten stream into particles and rapidly cooled the particles to about 160° C. in less than one second. Therefore, the cooling rate of the molten mass was at least 1000° C. per second. The incidence angle of the air stream impinging on the molten stream is approximately 90°. However, the angle (e.g. 20° to 160°) may vary according to the configuration of the processing equipment. In some embodiment, the impinged molten particles are impinged vertically downwards from the melting vessel.

The velocity of air emitted from the air gun is estimated to be at least 100 m/s. However, air guns with velocity of at least 300 m/s or at least 350 m/s may also be used.

The particulate matter travelled along a quenching chamber 30 before being collected on a steel mesh in a collection bin 40. No additional cooling medium is provided apart from the air gun. Additional cooling may be added to the quenching chamber including a positive inert gas stream, which may run counter-current to the molten particle stream to further increase the cooling rate the thereby increase the amorphous content. Although in some embodiments, the use of pressure jets to shape and quench the molten stream is sufficient to obtain the target morphology.

ICP analysis results confirmed that the formula approximating Li_{5.8}Al_{0.4}La₃Zr_{1.95}Mo_{0.05}O₁₂ was achieved.

SEM images (FIG. 2) of the particles revealed predominately spherical particles down to about 1-2 μm and even smaller (e.g. sub-micron particles).

A sample of 21 particles from FIG. 2 were analysed for particle characteristics including particle size and sphericity, with the results presented in Table A. Data analysis was carried out using Scandium™ 5.1 software.

As illustrated in FIG. 2 there are particles with a diameter of about 2 μm and about 3 μm and about 4 μm and about 5 μm at the smaller end of the range. Whilst FIG. 2 illustrates particles at the larger end of the range with a diameter of about 20 μm and about 30 μm and about 40 μm. The skilled artisan would have expectations that with further optimisation of the process, submicron particles could be obtained in sufficient quantities to segregate and used for end-use applications as required.

TABLE A

| | Diameter | Diameter | |
|---|---|---|---|
| Particle No. | (min) | (max) | Sphericity |
| 1 | 2.40 | 3.10 | 0.76 |
| 2 | 2.97 | 3.15 | 1.0 |
| 3 | 3.03 | 3.78 | 0.89 |
| 4 | 3.21 | 3.92 | 0.82 |
| 5 | 3.78 | 3.97 | 1.0 |
| 6 | 3.69 | 4.03 | 0.98 |
| 7 | 5.94 | 6.17 | 1.0 |
| 8 | 5.63 | 6.25 | 0.96 |
| 9 | 7.11 | 7.73 | 0.94 |
| 10 | 8.03 | 8.49 | 0.93 |
| 11 | 7.66 | 10.20 | 0.63 |
| 12 | 13.55 | 14.15 | 0.96 |
| 13 | 14.87 | 15.41 | 0.98 |
| 14 | 15.35 | 17.47 | 0.8 |
| 15 | 17.96 | 18.20 | 1.0 |
| 16 | 18.51 | 19.14 | 0.98 |
| 17 | 22.13 | 22.39 | 1.0 |
| 18 | 19.12 | 23.32 | 0.83 |
| 19 | 22.91 | 24.21 | 0.96 |
| 20 | 22.92 | 28.47 | 0.73 |
| 21 | 8.88 | 34.08 | 0.08 |
| Average | 10.9 | 13.2 | 0.87 |
| Min. | 2.4 | 3.1 | 0.08 |
| Max. | 22.9 | 34.1 | 1.0 |

As derivable from Table A, the average maximum distance between a central axis of the particles and a nearest surface is 13.2/2=6.6 μm and the average minimum cross-sectional dimension of the particles is 10.9 μm. The D50 (based upon the maximum diameter) is 10.2 μm.

From the 21 samples, the range of the maximum distance between a central axis of the particles is between 3.1 μm and 34.1 μm and the range of sphericity was between 0.08 and 1.0. Sample 21, with the sphericity of 0.08, is associated with the oblong shaped particle clearly identifiable in FIG. 2. The other particles (with a sphericity value of at least 0.63) may be regarded as at least spherical-like.

### Effect of Particle Size on Crystal/Amorphous Morphology

Quantitative phase analysis was performed on a size fraction of Al doped LLZO powders with differing amounts of Al dopant.

Rietveld quantitative amorphous content analysis was performed with reference to: De La Torre et al., J. Appl. Cryst., (2001) 34 196-202; and Chapter 5—Quantitative phase analysis in Practical Powder Diffraction Pattern Analysis using TOPAS. R. E. Dinnebier, A. Leinewber, J. S. O. Evans

LaB₆ used as internal standard for spiking. Masses of sample and LaB₆ were recorded (next slide) and powders were mixed by hand grinding for 10 minutes. Particle size used for Brindley correction in refinement is 45 μm.

LaB₆ MAC=237.405 cm² g⁻¹; LaB₆ LAC=1116.067 cm⁻¹

Li₇La₃Zr₂O₁₂ MAC=205.267 cm² g⁻¹; Li₇La₃Zr₂O₁₂ LAC=1040.262 cm⁻¹

Brindley correction and LAC values applied in refinement.

Absolute weight fractions of known materials can then be calculated by:

$${W}_{k ( absolute )} = {W}_{k ( sample )} \frac{{W}_{k ( standard )}}{{W}_{k ( standard - ref )}}$$

Weight fraction of unknown or amorphous material comes from:

$${W}_{( amorphous )} = 1 - {\sum }_{k} {W}_{k ( absolute )}$$

As indicated in Table 1, the amount of amorphous phase increased as the particle size decreased, with the ratio of the cubic to tetragonal phases remaining similar. The samples in Table 1 were obtained by the process described in Example 1. The change in dopant level did not appear to have a substantive effect on the morphology, with samples 1252 and 0981 possessing similar proportions of cubic and tetragonal crystalline material, despite the Al doping level in sample 0981 being twice that of sample 1252.

TABLE 1

| Sam- | | | Cubic | Tetragonal | Crystal. | Amorph. |
|---|---|---|---|---|---|---|
| ple | Composition | Size range | % wt | % wt | % wt | % wt |
| 0960 | LLZO | 180-355 μm | 15.3 | 30.7 | 46.0 | 54.0 |
| 1421 | LLZO | <180 μm | 15.3 | 30.7 | 46.1 | 53.9 |
| 0906 | Al_{0.25} LLZO | 350+ μm | 26.2 | 12.5 | 49.3 | 50.9 |
| 1252 | Al_{0.26} LLZO | 40-180 μm | 13.2 | 5.9 | 23.4 | 76.6 |
| 0976 | Al_{0.50} LLZO | 500+ μm | 29.3 | 12.9 | 50.2 | 49.8 |
| 0981 | Al_{0.50} LLZO | 40-180 μm | 13.8 | 6.1 | 28.8 | 71.2 |
| 1454 | Ta_{0.50} LLZO | <20 μm | 9.7* | 7.3* | 16.0 | 84.0 |
| 1632 | Nb_{0.5} LLZO | 355-500 μm | 77.6 | 0 | 77.6 | 22.4 |
| 1780 | Nb_{0.5} LLZO | 180-355 μm | 46.9 | 0 | 46.9 | 53.1 |
| 1703 | Nb_{0.5} LLZO | <20 μm | 14.0 | 0 | 14.0 | 86.0 |
| 1745 | LLTO | 38-45 μm | n.a. | n.a | 63.6 | 36.5 |
| 1777 | LTO | 45-180 μm | n.a | n.a | 44 | 56 |

*due to the high amorphous content, the accuracy of minor crystalline phases (e.g. around or less than 15 wt %) is reduced.

### Comparative Example (Samples 0960 and 1421)

Example 1 was repeated under the same conditions but without the addition of the Al₂O₃ dopant. The XRD from the resultant particles produced indicated that a major amorphous phase was still produced, but the amount of the tetragonal phase was about twice that of the cubic phase. This highlights the effect of the dopants in stabilising the cubic phase in preference to the less ionically conductive tetragonal phase. The results also appear to indicate that the amorphous content is not dependent upon particle size for undoped samples of LLZO.

### Example 2: Formation of LLZO Membrane

A Ta doped LLZO powder was produced in accordance with the previously described method. The resultant powder had a stoichiometric formula of about Li_{6.5}La₃Zr_{1.5}Ta_{0.5}O₁₂ with a D50 particle size of 18 μm. The powder was first milled to a D50 particle size of 1.2 μm (i.e. a size reduction factor of 18/1.2=15.)

The milling step involved roll milling the LLZO particles with ZrO₂ particles (10 mm diameter beads) in a ratio of 10:1 ZrO₂:LLZO weight ratio in ethanol for 24 hours. The milled product was end fired in a glovebox anti-chamber and stored in the glove box. There was no exposure to atmospheric H₂O, thereby reducing the likelihood of surface hydroxide formation. The milling step may have been eliminated through the formation of a smaller particle size powder or the use of screens and air classification separation techniques to produce a fine particle size powder.

A slurry was prepared from the powder and 1 wt % Al₂O₃ was added as a sintering aid. The slurry was used in a tape casting process to form a membrane having a thickness ranging from 36 to 150 μm.

The membrane was heat treated at 1320° C. for 2 minutes and then at 1200° C. for 9 hours to sinter and densify particles. The resultant relative density of the membrane was 97% and the total conductivity of the membrane (measured by EIS) was determined to be 0.15 mS/cm at 20° C.

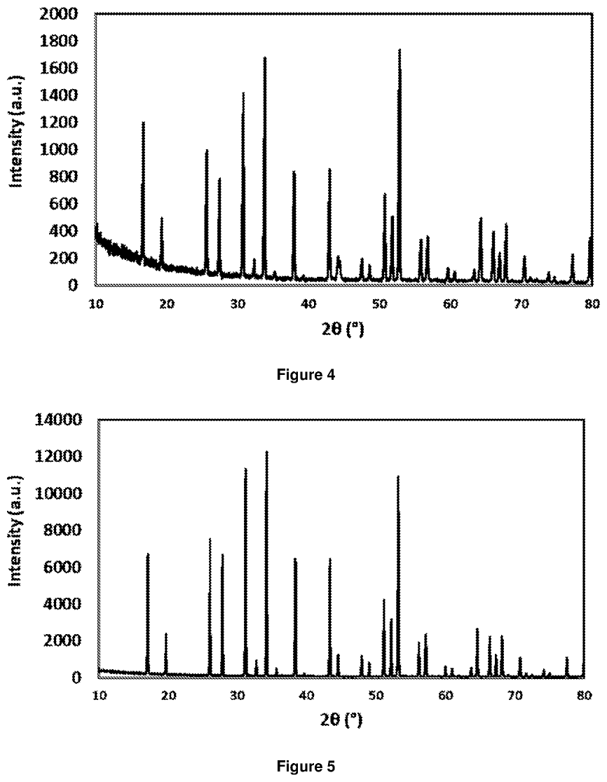

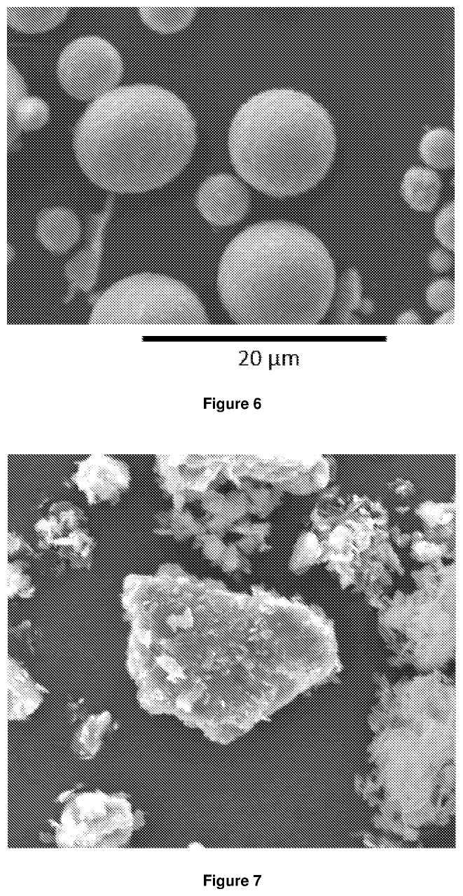

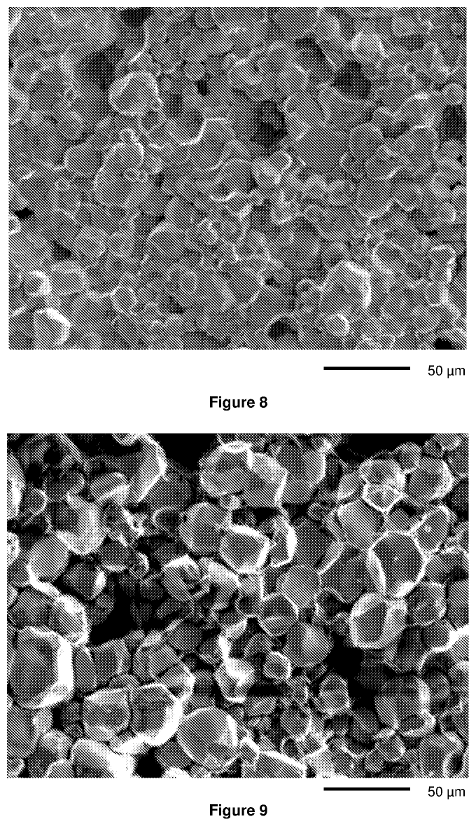

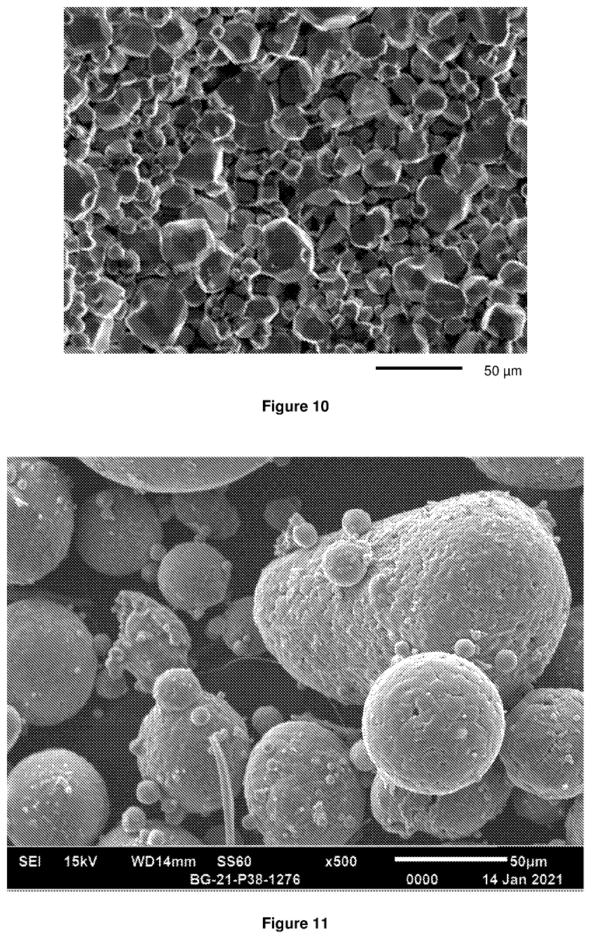

The XRD spectrum of the powder (FIG. 4) and resultant membrane (FIG. 5) indicated a transformation in the Ta-LLZO powder with an amorphous content of 84 wt % and also containing a 9.7 wt % cubic and 7.3 wt % tetragonal garnet crystalline phase to a Ta-LLZO membrane with an increased cubic garnet crystalline phase and a significant reduction in the amorphous phase as indicated in the XRD spectrum of FIG. 5.

The amorphous and crystalline phases were determined by Rietveld refinement from pXRD spiked with 2.5 wt % LaB₆.

### Example 3: Impact of Amorphous Content and Particle Size on Densification and Conductivity

Three samples of Nb doped LLZO with a composition of Li_{6.5}La₃Zr_{1.5}Nb_{0.5}O₁₂ (0.5Nb-LLZO) were used to prepare a solid electrolyte membrane. Except where indicated, the milling procedure (e.g. milling beads and solvent) was performed as indicated in Example 2.

Sample 1632 is a sample which has been milled from a D50 size of 26.6 μm to a D50 size of 0.72 μm (size reduction factor=36.9) using a planetary ball-mill at a speed of 400 rpm for 6×20 minutes cycles. Sample 1632 has an amorphous content of 22.4 wt %.

Sample 1703 comprises unmilled and spherical particles having a D50 of 7.2, possessing an amorphous content of 85 wt %.

Sample 1703 (milled) comprises sample 1703 which has been milled from a D50 size of 7.2 μm to a D50 size of 0.76 (size reduction factor of 9.5) μm using a planetary ball-mill at a speed of 400 rpm for 6×20 minutes cycles.

The particle size distribution characteristics of the samples are provided in Table 2.

TABLE 2

| Sample | D10 | D50 | D90 |
|---|---|---|---|
| 1632 | 0.54 | 0.72 | 2.4 |
| 1703 | 0.48 | 7.2 | 26.9 |
| 1703 (milled) | 0.54 | 0.76 | 3.1 |

Each of the samples were prepared into pressed pellets by sintering the pellets in a MgO boat crucible with lid. A heating ramp rate of 5° C./min was used from 20° C. to 1290° C. after which the sample was held for 7 minutes before the pellet was allowed to cool.

The relative density and conductivity of the membranes derived from the respective samples are provided in Table 3.

TABLE 3

| | | Conductivity |
|---|---|---|
| Sample | Relative density (%) | (10⁻⁴ S/cm) |
| 1632 (milled) | 96 | 4.4 |
| 1703 | 94 | 3.2 |
| 1703 (milled) | 94 | 5.0 |

The results indicate that despite have a lower relative density than sample 1632, sample 1703 (milled) has 15% higher conductivity. Additionally, the unmilled sample 1703 still obtained good conductivity despite not possessing an optimal particle size distribution for membrane formation. This highlights the benefits of using high amorphous content particles in the formation of solid electrolytes.

### Example 4—Crystallite Size

The peak shape of a diffraction peak at position Xcan be understood as the convolution of several different contributions. The two most fundamental contributions are the instrumental contribution, IBF(X) (Instrumental Resolution Function) and the sample contribution MS(X) (MicroStructure). Therefore, the overall peak profile of a particular reflection is described as a convolution of these two contributions. For quantitative interpretation of structural line broadening in terms of crystallite size, both IRF^{hkl} and MS^{hkl} terms must be considered separately.

To measure MS we first determine the IRF using a standard material with negligible structural line broadening. The parameters describing IRF were then fixed when evaluating diffraction data for Sample 1A (LLZNO-20), Sample 1C (LLZNO-85) and Sample 1B (LLZNO-50). The additional sample broadening is then modelled by refining suitable parameters. The IRF was determined using LaB₆ powder (space group Pm3⁻m, lattice parameter a=4.155 Å) as a line profile standard. Diffraction data were collected between 10-120° 2θ, step size 0.016°, time per step 210 s. The profile was fit using a Pseudo-Voigt profile function, using the Caglioti equation to describe peak widths as a function of theta: allowing U, W, V, Peak shapes 1 and 2 to refine. The refined profile and shape parameters were then used to model the MS of the samples, collecting diffraction data using the same optics and scan details as for LaB₆. A “crystallite” is equivalent to “homogenous domain giving rise to coherent diffraction”, so it is supposed that there is no complete break in the three-dimensional order inside it.

TABLE 4

| | Amorphous | Crystallite size | |
|---|---|---|---|
| Sample | content % wt | (Angstrom, Å) | Growth rate |
| 1632 | 20 | 861 | 34% |
| 1780 | 50 | 689 | 29% |
| 1703 | 85 | 629 | 46% |

The results (Table 4) indicate that crystallite size decreases as a function of particle size and with increased amorphous content. Further, the crystallite growth rate (heating ramp rate of 5° C./min from 20° C. to 1000° C.) for higher amorphous content particles (e.g. sample 1703) was higher than with particles with lower amorphous content (e.g. sample 1632).

### Example 5—LTO Particle Formation

Melt-blown particles of Li₄Ti₅O₁₂ were synthesised from Li₂CO₃ and TiO₂ precursors using a 30% molar excess of Li (i.e. Li_{5.2}Ti₅O₁₂) using the furnace as described in Example 1. The chemical composition of the final product analysed via ICP-OES was determined to have a stoichiometric composition of Li_{4.1}Ti_{5.}Mo_{0.283}O₁₂. The Mo content was derived from the molybdenum electrodes of the furnace.

The melting temperature and fluid impingement conditions were similar to that described in Example 1, with the PSD ranging from about 1 to 500 μm. The particles were sieved through 500, 180 and 45 μm meshes, with most of the particles being in the 45 to 180 μm range. Further analysis (via laser diffraction techniques) determined that the 45-180 μm fraction had an average particle size of 81 μm, with a standard deviation of 76 μm.

The relative proportions of crystalline and amorphous components in the materials were assessed by Rietveld analysis by mixing the 45-180 μm fraction with a suitable internal standard (TiO₂, 20 wt %). As indicated in Table 1, the amorphous content of sample 1777 was found to be 56 wt %. A SEM image of the 45-180 μm fraction reveal that the particles are generally spherical in shape (FIG. 11).

### Electrochemical Performance of LTO as an Anode Material

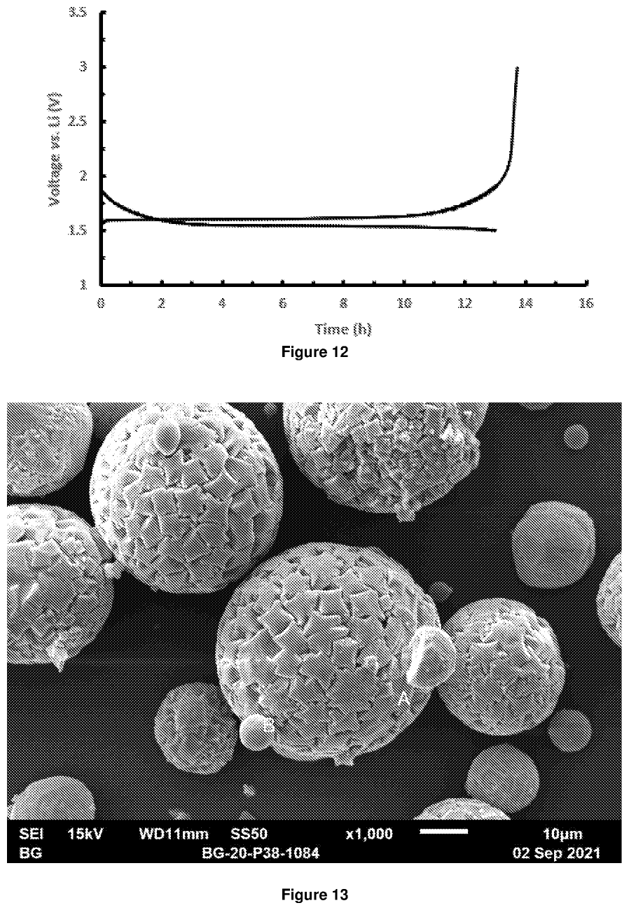

Electrochemical performance as anode materials were investigated in lithium half cells using 1M LiPF₆ dissolved in 1:1 ethylene carbonate:dimethyl carbonate as an electrolyte. The LTO electrode was made by mixing the LTO (45-180 μm fraction) with conductive carbon in a pestle and mortar in 70%:30% mass ratio for 20 minutes. Galvanostatic charge discharge plots (FIG. 12) were obtained with voltage limits of 1.5 V and 3.0 V and a controlled temperature of 20° C. Reversible capacity of 152 mAh g⁻¹ were obtained for multiple cells. This is marginally lower than the expected capacity (160 mAh g⁻¹), with the discrepancy most likely a function of electrode fabrication.

### Example 6—LLTO Particle Formation

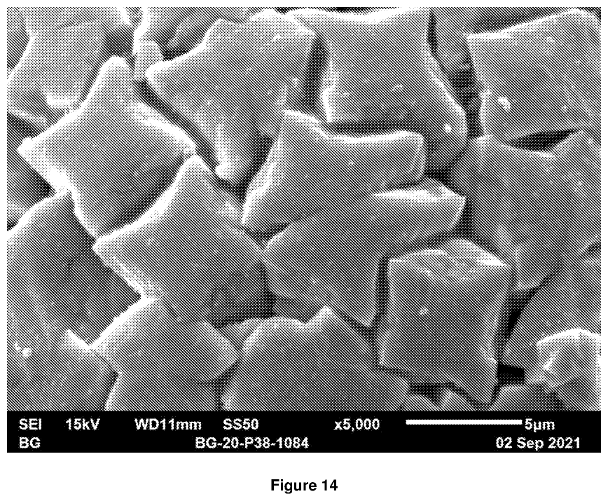

Melt-blown particles of the general composition Li₃ₓLa_{(2/3)-x}TiO₃ (0<x<0.16) were synthesised from Li₂CO₃, La₂O₃ and TiO₂ using a 30% molar excess of Lithium using the furnace as described in Example 1. The chemical composition of the final product(s) were determined by ICP-OES to be Li_{0.36}La_{0.54}Ti_{1.01}O₃. The relative proportions of crystalline and amorphous components in the materials were assessed by Rietveld analysis by mixing the 38-45 μm fraction with a suitable internal standard (TiO₂, 20 wt %). As indicated in Table 1, the amorphous content was found to be 36.5 wt %. A SEM image of the particles indicates that they are generally spherical in shape (FIG. 13). As indicated in FIG. 14, the predominant crystalline phase may be observed thorough the angular morphology on the spherical particle's surface. The morphology of the particles change with particle size as indicated in FIG. 13, with the larger spheres (e.g. particle A) possessing an a surface comprising angular grains, whilst smaller spherical particles (e.g. particle B) possessing a smoother surface, consistent with a particle with a higher amorphous content. Particles with a higher amorphous content may be obtained through either particle size separation techniques (e.g. sieving and/or air classification) or the production parameters may be changed (e.g. increase the fluid impingement velocity on the molten mass and/or increasing the quenching rate of the atomised particles of the molten mass formed during fluid impingement.)

### Clauses

1. A process for the production of a lithium ion conductive shaped article, or precursor thereof, comprising the steps of:
A. Feeding a mixture of raw materials into a melting vessel;
B. Melting the raw materials in the melting vessel to form a molten mass;
C. Shaping the molten mass; and
D. Quenching the molten mass with a cooling medium to produce the shaped article
   wherein the cooling rate of the molten mass is sufficient to form a glass or glass ceramic shaped article and wherein the molten mass is shaped prior to or at the same time as being quenched.

2. The process according to clause 1, wherein the cooling medium is a fluid cooling medium.

3. The process according to clause 2, wherein the molten mass is shaped at the same time as being quenched by a fluid cooling medium.

4. The process according to clauses 2, wherein the molten mass and the fluid cooling medium impact together to thereby atomise the molten mass into a shaped article.

5. The process according to clause 2, wherein the molten mass is quenched and shaped through the fluid cooling medium impinging on the molten mass.

6. The process according to any one of clauses 2 to 5, further comprising the step of feeding a stream of molten mass into a quenching chamber, said quenching chamber comprising an inlet for admitting a stream of molten mass to enter the vessel; and at least one nozzle is arranged to direct a pressure jet of a fluid cooling medium to impinge upon the stream of molten mass causing the molten mass stream to atomise into particles.

7. The process according to any one of the preceding clauses, wherein the molten mass stream, which is impinged by the cooling medium, is a plurality of droplets.

8. The process according to any one of the preceding clauses, wherein the cooling medium is a gas stream, a liquid stream or a moving object.

9. The process according to clause 8, wherein the gas stream is an inert gas or air.

10. The process according to clauses 8 or 9, wherein the fluid cooling medium is a compressed fluid stream with a velocity of 5 m s⁻¹ to about 2000 m s⁻¹.

11. The process according to any one of the preceding clauses, wherein the molten mass is quenched to less than 600° C.

12. The process according to any one of the preceding clauses, wherein a dopant is provided to the melting vessel via a sacrificial electrode.

13. The process according to any one of the preceding clauses, wherein the shaping step is conducted at a temperature less than 200° C. difference to the temperature of the molten stream leaving the melting vessel.

14. The process according to any one of the preceding clauses, wherein the shaped article is a sheet, a film, a particle, platelet or a fibre.

15. The process according to any one of the preceding clauses, wherein the cooling rate of the molten mass is sufficient to form particles comprising at least 60 wt % amorphous phase.

16. The process according to any one of the preceding clauses, wherein the process produces a plurality of shaped articles.

17. The process according to any one of the preceding clauses, wherein the shaped article(s) comprise a major amorphous phase and a minor crystalline phase.

18. The process according to any one of the preceding clauses, wherein said shaped article comprises an average maximum distance between a central axis of the shaped article(s) and a nearest surface of less than 10 mm and said shaped article(s) comprises an average minimum cross-sectional dimension of more than 500 nm.

19. The process according to any one of the preceding clauses, wherein said shaped article comprises an average maximum distance between a central axis of the shaped article(s) and a nearest surface of less than 250 μm.

20. The process according to any one of the preceding clauses, wherein said shaped article comprises an average maximum distance between a central axis of the shaped article(s) and a nearest surface of less than 100 μm.

21. The process according to any one of the preceding clauses, wherein said shaped article(s) comprises an average minimum cross-sectional dimension of more than 500 nm.

22. The process according to any one of the preceding clauses, wherein the shaped article(s) comprises a garnet-like, a perovskite-like or a spinel like composition.

23. The process according to any one of the preceding clauses, wherein the shaped article(s) are spherical or spherical-like.

24. The process according to any one of the preceding clauses, wherein the shaped article(s) comprises a core shell configuration.

25. The process according to any one of the preceding clauses, wherein the quenched shaped article(s) undergo destructive particle size reduction to reduce the particle D50 by a factor of less than 100.

26. The process according to any one of the preceding clauses, further comprising the steps of:
A. Forming the shaped articles into a layer;
B. Heat treating the layer to densify the layer; and
C. Maintaining the heat treatment for sufficient time to achieve a targeted morphology.

27. The process according to any one of the preceding clauses, wherein the shaped articles are spherical particles with an average maximum distance between a central axis of the particle and the nearest surface of the particles is less than 10 μm and wherein said particles comprise an amorphous content of at least 50 wt % amorphous phase.

28. The process according to any one of the preceding clauses, wherein the average maximum distance between a central axis of the shaped article(s) and the nearest surface of the particles is less than 225 μm and the average minimum cross-sectional dimension of the particles is more than 600 nm.

29. An ionically conductive vitreous shaped article obtained or obtainable by the process according to any one of the preceding clauses.

30. An ionically conductive vitreous shaped article comprising a garnet-like, a perovskite-like or a spinel like composition, wherein the average maximum distance between a central axis of the shaped article and a nearest surface is less than 10 mm and wherein the shaped article comprise at least 50 wt % amorphous phase.

31. The ionically conductive vitreous shaped article of any one of clauses 29 or 30, wherein the shaped article comprise at least 60 wt % amorphous phase.

32. The ionically conductive vitreous shaped article of any one of clauses 29 to 31, wherein the average maximum distance between a central axis of the shaped article and a nearest surface is less than 250 μm.

33. The ionically conductive vitreous shaped article of any one of clauses 29 to 32, wherein the average maximum distance between a central axis of the shaped article and a nearest surface is less than 100 μm.

34. The ionically conductive vitreous shaped article of any one of clauses 29 to 33, wherein the average maximum distance between the central axis of the shaped article and a nearest surface is no greater than 10 μm.

35. The ionically conductive vitreous shaped article of any one of clauses 29 to 34, wherein said shaped article comprises an average minimum cross-sectional dimension of more than 500 nm.

36. The ionically conductive vitreous shaped article of any one of clauses 29 to 35, wherein said shaped article comprises or consists of spherical or spherical-like particles

37. The ionically conductive shaped article according to clause 36, wherein the spherical or spherical-like particles comprises an average minimum cross-sectional dimension of more than 600 nm.

38. The ionically conductive vitreous shaped article according to clause 36 or 37, wherein the particles comprise a minimum cross-sectional dimension of the particles in the range of 2.4 μm to 22.9 μm.

39. The ionically conductive vitreous shaped article according to any one of clauses 29 to 36, wherein the particles comprise a minimum cross-sectional dimension of the particles of at least 2.4 μm.

40. The ionically conductive vitreous shaped article according to any one of clauses 36 to 39, wherein the particles comprise a particle size distribution with a D50 in the range of 600 nm to 20 μm.

41. The ionically conductive vitreous shaped article according to any one of clauses 36 to 40, wherein the particles comprise a particle size distribution with a D50 of greater than 1 μm.

42. The ionically conductive vitreous shaped article according to any one of clauses 36 to 41, wherein the particles comprise a sieve size fraction in the range of 40 μm to 180 μm.

43. The ionically conductive vitreous shaped article according to any one of clauses 29 to 42, comprising a crystalline phase with an average crystallite size of less than 690 Å.

44. The ionically conductive vitreous shaped article according to any one of clauses 29 to 43, comprising an amorphous phase of at least 80 wt %.

45. The ionically conductive vitreous shaped article according to any one of clauses 29 to 44, wherein the garnet-like composition comprises lithium lanthanum zirconium oxide or doped lithium lanthanum zirconium oxide.

46. The ionically conductive vitreous shaped article according to any one of clauses 29 to 45, wherein the perovskite-like composition comprises lithium lanthanum titanium oxide or doped lithium lanthanum titanium oxide.

47. The ionically conductive vitreous shaped article according to any one of clauses 29 to 46, wherein the spinel-like composition comprises lithium titanate or doped lithium titanate.

48. A membrane produced by sintering the ionically conductive vitreous shaped article of clauses 29 to 47.

49. Use of the ionically conductive vitreous shaped article according to any one of clauses 29 to 47, in the manufacture of a solid electrolyte or an electrode.

For the avoidance of doubt it should be noted that in the present specification the term “comprise” in relation to a composition or a particle size range (e.g. 40 μm to 180 μm) is taken to have the meaning of include, contain, or embrace, and to permit other ingredients or other particles sizes to be present. The terms “comprises” and “comprising” are to be understood in like manner. Many variants of the shaped article, including shaped particles, of the present disclosure will be apparent to the person skilled in the art and are intended to be encompassed by this disclosure.

1. A process for the production of a lithium ion conductive shaped articles, or a shaped article capable of transformation thereto, comprising:
feeding a mixture of raw materials into a melting vessel;
melting the raw materials in the melting vessel to form a molten mass;
shaping the molten mass; and
quenching the molten mass to produce the shaped articles,
wherein the cooling rate of the molten mass is sufficient to form a glass or glass ceramic shaped article and wherein the molten mass is shaped prior to or at the same time as being quenched by a fluid cooling medium.

2. The process according to claim 1, wherein the molten mass is shaped at the same time as being quenched by a fluid cooling medium.

3. The process according to claim 1, wherein the molten mass is quenched and shaped through the fluid cooling medium impinging on the molten mass.

4. (canceled)

5. (canceled)

6. (canceled)

7. The process according to claim 1, further comprising feeding a stream of molten mass into a quenching chamber, said quenching chamber comprising an inlet for admitting a stream of molten mass to enter the quenching chamber; and at least one nozzle arranged to direct a pressure jet of a fluid cooling medium to impinge upon the stream of molten mass causing the molten mass stream to atomise into particles.

8. The process according to claim 7, wherein the chamber comprises two nozzles.

9. (canceled)

10. (canceled)

11. The process according to claim 7, wherein the quenching chamber comprises an inert gas at a positive pressure to prevent the ingress of air into the chamber.

12. (canceled)

13. (canceled)

14. (canceled)

15. The process according to claim 1, wherein the fluid cooling medium has a velocity in the range of 0.5 m s⁻¹ to about 2000 m s⁻¹.

16. (canceled)

17. The process according to claim 1, wherein the fluid cooling medium is a compressed gas.

18. The process according to claim 1, wherein the shaped article is spherical or spherical like.

19. The process according to claim 1, wherein said shaped article has an average maximum cross-sectional dimension of less than 500 μm.

20. (canceled)

21. The process according to claim 1, wherein the shaped article is a sheet, a film, a particle, platelet or a fibre.

22. (canceled)

23. (canceled)

24. (canceled)

25. The process according to claim 1, wherein said shaped article has an average minimum cross-sectional dimension of more than 500 nm.

26. The process according to claim 1, wherein the lithium ion conductive shaped articles have a garnet-like, a perovskite-like or spinel like composition composition.

27. (canceled)

28. (canceled)

29. (canceled)

30. The process according to claim 1, wherein the cooling rate of the molten mass is sufficient to form the shaped article comprising at least 60 wt % amorphous phase.

31. (canceled)

32. (canceled)

33. (canceled)

34. (canceled)

35. (canceled)

36. (canceled)

37. (canceled)

38. (canceled)

39. (canceled)

40. A lithium ion conductive shaped article, or precursors thereof obtained or obtainable by the process according to claim 1.

41. Ionically conductive vitreous particles comprising a garnet-like, a perovskite-like or a spinel-like composition, wherein the average maximum distance between a central axis of the particles and a nearest surface is less than 250 μm, an average minimum cross-sectional dimension of the particles is more than 500 nm, and wherein the particles are spherical or spherical like and comprise at least 50 wt % amorphous phase.

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. A composite material comprising a solvent soluble inorganic binder matrix comprising:
a solvent soluble inorganic binder; and
a plurality of the ionically conductive vitreous particles according to claim 41,
wherein the ionically conductive vitreous particles are present in a range from 20 wt % to 99.5 wt % based upon the total weight of the ionically conductive particles and the solvent soluble inorganic binder.

59. A process for forming a membrane, comprising:
forming the ionically conductive vitreous particles according to claims 41 into a layer;
heat treating the layer to densify the layer; and
maintaining the heat treatment for sufficient time to achieve a targeted morphology.

60. (canceled)

61. The process according to claim 59, wherein the the heat treating to densify the layer transforms predominantly amorphous particles to a predominately crystalline membrane.

62. (canceled)

63. A membrane produced according to claim 59, wherein the ionically conductive vitreous particles comprise a garnet-like, a perovskite-like or a spinel-like composition, wherein particle size D50 is in the range of 600 nm to 20 μm; the sphericity is 0.7 or greater; and the particles comprise at least 50 wt % amorphous phase.

64. (canceled)
